(19) United States
(12) Patent Application Publication
(10) Pub. No.: US 2024/0246715 A1
(43) Pub. Date: Jul. 25, 2024

(54) CONTAINER WITH A ONE-PIECE CONTAINER BODY COMPRISING FIBERS AND A CLOSURE THEREFOR, METHOD FOR MANUFACTURING A CONTAINER BODY, DEVICE AND METHOD FOR CLOSING A CONTAINER BODY BY MEANS OF A CLOSURE

(71) Applicant: Krones AG, Neutraubling (DE)

(72) Inventors: Ulrich LAPPE, Neutraubling (DE); Konrad SENN, Alteglofsheim (DE); Barbara WEIN, Gonnersdorf (DE); Frank WINZINGER, Regensburg (DE); Angelika GROSSER, Emmerting (DE); Jörg ZACHARIAS, Koefering (DE)

(21) Appl. No.: 18/421,689

(22) Filed: Jan. 24, 2024

(30) Foreign Application Priority Data
Jan. 24, 2023 (DE) 102023101647.4

(51) Int. Cl. B65D 3/06; B65D 39/00; B65D 41/40; B65D 65/46

(52) U.S. Cl. CPC B65D 3/06; B65D 39/0011; B65D 41/40; B65D 65/466

(57) ABSTRACT

The disclosure relates to a container having a one-piece container body comprising fibers and having a mouth opening and a closure for the container body. The closure is at least partially inserted in a closure position into the mouth opening, the closure, in cooperation with an inner surface of the mouth opening, being positioned in the mouth opening at least partially with a non-positive fit, the container body is thereby closed. The closure is also designed to be moved from the closure position to an open position completely outside the container body. The disclosure further relates to a method for manufacturing a container body and to a method for manufacturing a closure for use with the container, a device for closing a container body by a closure, and a method for closing a container body by a closure by the device.

### TECHNICAL FIELD

The disclosure relates to a container having a one-piece container body comprising fibers and having a mouth opening and a closure for the container body, a method for manufacturing a container body for use for the container, a method for closing a container body by means of a closure, a device for closing a container body by means of a closure, a method for closing a container body by means of a closure, a closure, and a system for manufacturing a closed container comprising fibers.

### BACKGROUND

It is known to equip containers comprising fibers with a plastic thread and plastic lids in order to be able to ensure reclosability of such a container. Reclosability of containers can be desirable in particular in the case of filling quantities of more than 200 mL, since this quantity is generally not emptied in one go. Due to the different materials, the container is not compostable and is also difficult to recycle.

### SUMMARY

### Object

The object of the disclosure is to provide a container having a one-piece container body comprising fibers and having a mouth opening and a closure for the container body, a method for manufacturing a container body for use for the container, a method for closing a container body by means of a closure, and a method for closing a container body by means of a closure, which can enable closability and reclosability of a container comprising fibers without the provision of a thread.

### Achievement

The object is achieved by the container having a one-piece container body comprising fibers and having a mouth opening and a closure for the container body, the method for manufacturing a container body for use for the container, the method for closing a container body by means of a closure, a device for closing a container body by means of a closure, the method for closing a container body by means of a closure, the closure, and the system for manufacturing a closed container, comprising fibers.

The container according to the disclosure having a one-piece container body comprising fibers and having a mouth opening and a closure for the container body, wherein the closure is at least partially inserted in a closure position into the mouth opening, wherein the closure, in cooperation with an inner surface of the mouth opening, is at least partially positioned in the mouth opening with a non-positive fit, and the container body is closed thereby, wherein the closure is further designed to be moved from the closure position to an opening position completely outside the container body.

Since the closure, in cooperation with an inner surface of the mouth opening, is positioned at least partially with a non-positive fit in the mouth opening, and the container body is thereby closed, a thread on the container body can be dispensed with, as can a screw closure for screwing onto the thread. In contrast to conventional rotary closures, the sealing surface can be much larger, making it easier to achieve a seal.

The closures described in the application can consist of solid material or can comprise one or more cavities.

The one-piece container body comprising fibers and having the mouth opening and the closure can be manufactured with simple geometric shaping of the outer surfaces.

The fibers may comprise lignin, banana leaves, and/or wild quinine. The fibers may for example, comprise cellulose fibers, fibers of conifers, leafy woody plants, and/or plane trees and/or grasses, reeds and/or bamboo or the like. The fibers may comprise silk threads, spider silk, algae, natural fibers (such as Danube silphie fibers, hemp, maize, cotton), banana peel, orange peel, grass, straw, potato starch, or processed cow dung. It is also possible to provide cellulose fibers which originate from a process by which they were artificially grown. In the event of material bottlenecks of wood as the basic material for a fluid mass with fibers, these alternative materials can completely or partially replace the basic material.

The fibers can comprise fiber mixtures made of non-wood material—for example, cotton, hemp, and/or textile fibers.

For example, the fibers may comprise viscose fibers. A viscose fiber is an artificial fiber made of regenerated cellulose, wherein the viscose fibers have, as starting base, 100% cellulose treated in a multi-stage process. The viscose fibers may comprise a flat or cable-shaped structure, a trilobal shape, or a double trilobal structure. The fibers may comprise a flat or hollow structure or a corrugated or rough outer surface.

Various types of fibers may also be used in combination. For example, fibers with different outer surfaces and/or shapes and/or hollow structure and/or flat structure and/or various length distributions and/or of various materials may be combined.

Due to the natural origin of the fibers, they may be biodegradable. In addition, they are sustainable and renewable.

The fibers may be used in a pulp. The pulp may be or comprise a mixture of water, e.g., with additives, and fibers.

The one-piece container body can be a bottle, a barrel, or a can.

The molding of the one-piece container body comprising fibers using the fiber-containing pulp can take place in a mold, which can represent a negative form of an outer contour of the one-piece container body to be produced, or by means of an injection-molding method.

The fiber-containing pulp that is used for molding the one-piece container body comprising fibers and the fiber-containing pulp that is used to form a closure can be the same or different. If these are the same, they can be taken from the same source—for example, a pulp mixing vessel.

The closure can be designed in the form of a circular-cylindrical stopper.

The stopper can have a diameter and a height which can be dimensioned in such a way that the stopper can be at least partially insertable in a closure position into the mouth opening of the one-piece container body comprising fibers. For example, a diameter of the mouth opening can be the same size as the diameter of the stopper. The stopper can be at least partially elastic and/or can be introduced into the mouth with a certain pressure, or a diameter of the mouth opening can be minimally larger than the diameter of the stopper.

The stopper can have a first diameter in a first region and a second diameter in a second region. For example, the first diameter can be dimensioned such that, in cooperation with the inner surface of the mouth opening, the stopper can be positioned in the mouth opening with this first region with a non-positive fit. For example, the second diameter can be larger than the first diameter.

As already described above, the first diameter can be dimensioned such that, in cooperation with the inner surface of the mouth opening, the stopper, with a first circular cylinder which has the first diameter, can be positioned in the mouth opening with a non-positive fit. The second diameter can be larger than the first diameter, so that a second circular cylinder which has the second diameter cannot be introduced into the mouth opening. The second circular cylinder can serve as a gripping element for bringing the stopper out of the closure position into an open position.

The closure can be designed in the form of a circular cone. For example, the circular cone can be a truncated circular cone. For example, a maximum diameter of the circular cone can be dimensioned such that, in cooperation with the inner surface of the mouth opening, the closure can be positioned in the mouth opening with a non-positive fit.

The circular cone can have a diameter (the maximum diameter of the circular cone) and a height which can be dimensioned in such a way that the circular cone can be introduced at least partially into the mouth opening of the one-piece container body comprising fibers in the closure position. For example, a diameter of the mouth opening can be the same size as the diameter of the circular cone, and the circular cone can be at least partially elastic and/or can be introduced into the mouth with a certain pressure, or a diameter of the mouth opening can be minimally larger than the diameter of the circular cone.

The circular cone can be a straight or an inclined circular cone.

The circular cone can further comprise a circular cylinder. For example, a maximum diameter of the circular cone and a diameter of the circular cylinder can be the same. For example, the diameter can be dimensioned such that, in cooperation with the inner surface of the mouth opening, the closure can be positioned in the mouth opening with a non-positive fit.

The circular cone and the circular cylinder can then both position the closure with a non-positive fit in the mouth opening in cooperation with the inner surface of the mouth opening and thereby close the container body in the closure position.

The circular cone can comprise a first and a second circular cylinder. For example, a maximum diameter of the circular cone and a diameter of the first circular cylinder can be the same size, and a diameter of the second circular cylinder can be larger than the maximum diameter of the circular cone. For example, the maximum diameter can be dimensioned such that, in cooperation with the inner surface of the mouth opening, the closure can be positioned in the mouth opening with a non-positive fit.

The features already specified above can hold for the circular cone and for the first circular cylinder. The diameter of the second circular cylinder can be larger than the diameter of the circular cone, so that the second circular cylinder cannot be introduced into the mouth opening. The second circular cylinder can serve as a gripping element for moving the closure from a closure position into an open position.

The closure can be designed in the form of a circular cone which can comprise a bent tip.

The closure can be designed in the form of an inverted crown cap.

The crown cap can have a first diameter in a lid area and a second diameter in a crimping area at a height. The first diameter can be smaller than the second diameter. The second diameter and the height can be dimensioned in such a way that the closure can be at least partially insertable in a closure position into the mouth opening of the one-piece container body comprising fibers. For example, a diameter of the mouth opening can be the same size as the second diameter of the closure, so that the closure, in cooperation with the inner surface of the mouth opening, can be positioned at least partially with a non-positive fit in the mouth opening and can thereby close the container body.

At least those surfaces of the closure that can come into contact with a product present in the container can comprise a coating. For example, the coating can be food-safe and/or biodegradable and/or compostable and/or resistant to liquids. The closure can comprise a coating with wax.

The closure can comprise a captive securing device which can connect it to the container body in a captive manner. For example, the captive securing device can comprise a biologically degradable and/or compostable material.

The closure can comprise fibers—for example, wood and/or cellulose fibers, fibers of paper, or cardboard. The statements made above can also apply to the fibers.

The closure can comprise a material containing cork.

For example, a closure, e.g., for a bottle-shaped container, can have a height in the range of 2 cm to 7 cm and a diameter in the range of 1 cm to 3 cm.

A method for manufacturing a container body for use for the container as described above or below is provided.

The container body can be manufactured in one piece; for example, a fiber-containing pulp can be used. A mold that constitutes a negative form of an outer contour of the container body to be manufactured can be used. Or, the container body can be manufactured using an injection-molding method. The features described above can apply to the fibers of the fiber-containing pulp.

A method for manufacturing a closure for use for the container as described above or below is provided.

The closure can be manufactured using a fiber-containing pulp, for example, but other materials, such as a cork-containing material, can also be used. The fibers can comprise wood and/or cellulose fibers, and/or fibers made of paper or cardboard. In addition, the features already described above can apply to the fibers. A mold that constitutes a negative form of an outer contour of the closure to be manufactured can be used to manufacture the closure. Or the closure can be manufactured by means of an injection-molding process.

A device is provided for closing a container body, manufactured according to the method for manufacturing a container body for use for the container as described above or below, by means of a closure manufactured according to the method for manufacturing a closure for use for the container as described above or below.

In addition, a method is provided for closing a container body, manufactured according to the method for manufacturing a container body for use for the container as described above or below, by means of a closure manufactured according to the method for manufacturing a closure for use for the container as described above or below, by means of the device for closing the container body by means of the closure.

In addition, a device is provided for closing a one-piece container body comprising fibers by means of a closure, wherein, for example, the closure, in cooperation with an inner surface of a mouth opening of the container body, is positioned in a closure position at least partially with a non-positive fit in the mouth opening, and the container body is thereby closed.

Furthermore, a method is provided for closing a one-piece container body comprising fibers by means of a closure by means of the device (for example, mentioned in the previous section) for closing the container body by means of the closure. For example, the closure, in cooperation with an inner surface of the mouth opening of the container body, is positionable in a closure position in the mouth opening at least partially with a non-positive fit, and the container body is closable thereby.

In addition, a closure is provided which can be at least partially inserted in a closure position into a mouth opening of a container, wherein the closure, in cooperation with an inner surface of the mouth opening, can be positioned at least partially with a non-positive fit in the mouth opening, and the container body can thereby be closed, wherein the closure is further designed to be moved from the closure position to an opening position completely outside the container body, wherein the closure comprises a fiber-containing material.

In addition, a system is provided for manufacturing a sealed, fiber-containing container, comprising a device for manufacturing a container from fiber-containing material, a device for manufacturing a closure from fiber-containing material, and a device for closing the container, as well as a transport device for transporting the containers and the closures to a position at which the containers are closed with the closures.

The transport device can be transport stars which transport the containers, the closures, and/or the closed containers at least in regions along a meandering transport path.

The closure can be slightly compressed by means of a tool in the capper before insertion into the container mouth, so that it is reduced in diameter.

Likewise intended is a wire-shaped closure lock which, after the container has been closed, can be applied to the closure and the container. In particular, this can be arranged in an area of the container with a smaller diameter than the surrounding area, towards the container mouth and, in particular, tightened in such a way that it surrounds the container in this area.

Instead of pulp, the container and/or the closure can alternatively be made of dry fibers.

All aspects of the methods, containers, closures, and devices can be used or combined with each other, provided they are not mutually exclusive.

### BRIEF DESCRIPTION OF FIGURES

The accompanying figures show, by way of example, aspects and/or exemplary embodiments of the disclosure for better understanding and illustration. In the figures:

FIG. 1 shows a first embodiment of a closure,

FIG. 2 shows a second embodiment of a closure,

FIG. 3 shows a third embodiment of a closure,

FIG. 4 shows a fourth embodiment of a closure,

FIG. 5 shows a fifth embodiment of a closure,

FIG. 6 shows a sixth embodiment of a closure,

FIG. 7 shows a seventh embodiment of a closure,

FIG. 8 shows an eighth embodiment of a closure,

FIG. 9 shows a ninth embodiment of a closure,

FIG. 10 shows a closure in an open position, and

FIG. 11 shows a closure in a closure position.

### DETAILED DESCRIPTION OF FIGURES

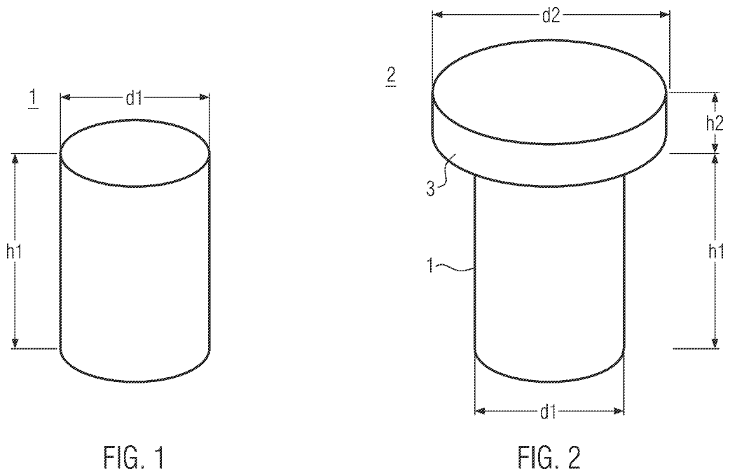

FIG. 1 shows a first embodiment of a closure 1 which is designed in the form of a circular-cylindrical stopper 1. The stopper 1 can have a diameter d1 and a height h1 which can be dimensioned in such a way that the stopper 1 can be at least partially insertable in a closure position into the mouth opening of the one-piece container body comprising fibers. For example, a diameter of the mouth opening is the same size as the diameter d1 of the stopper 1, and the stopper 1 can be at least partially elastic and/or can be introduced into the mouth with a certain pressure, or a diameter of the mouth opening can be minimally larger than the diameter d1 of the stopper 1.

In cooperation with an inner surface of the mouth opening, the stopper 1 can be positioned at least partially with a non-positive fit in the mouth opening and can thereby close the container body.

FIG. 2 shows a second embodiment of a closure 2 which is designed as a stopper 2 with a first circular cylinder 1 having a first diameter d1 and with a second circular cylinder 3 having a second diameter d2. As already described in FIG. 1, the first diameter d1 is dimensioned such that, in cooperation with an inner surface of a mouth opening, the stopper 2 can be positioned with the first circular cylinder 1 in the mouth opening with a non-positive fit. The second diameter d2 is larger than the first diameter d1, so that the second circular cylinder 3 cannot be introduced into the mouth opening. The second circular cylinder 3 can serve as a gripping element for bringing the stopper 2 out of a closure position into an open position.

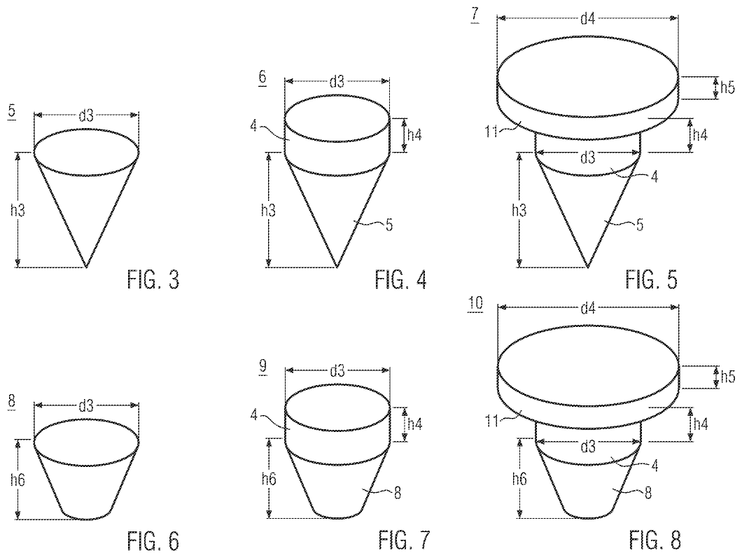

FIG. 3 shows a third embodiment of a closure 5 which is designed in the form of a circular cone 5. In the illustration, this is a straight circular cone 5, but an inclined circular cone can be provided instead. The circular cone 5 has a diameter d3 (the maximum diameter of the circular cone 5) and a height h3 which can be dimensioned in such a way that the circular cone 5 can be introduced in a closure position at least partially into a mouth opening of a one-piece container body comprising fibers. For example, a diameter of the mouth opening is the same size as the diameter d3 of the circular cone 5, and the circular cone 5 can be at least partially elastic and/or can be introduced into the mouth with a certain pressure, or a diameter of the mouth opening can be minimally larger than the diameter d3 of the circular cone 5.

In cooperation with an inner surface of the mouth opening, the circular cone 5 can be positioned at least partially with a non-positive fit in the mouth opening and can thereby close the container body.

FIG. 4 shows a fourth embodiment of a closure 6, which comprises the circular cone 5 and a circular cylinder 4 with the diameter d3 and a height h4. As already described in FIG. 3, the diameter d3 is dimensioned such that, in cooperation with an inner surface of a mouth opening, the closure 6 can be positioned in the mouth opening with a non-positive fit and can thereby close the container body in the closure position.

FIG. 5 shows a fifth embodiment of a closure 7, which comprises the circular cone 5 and the circular cylinder 4 with the diameter d3 and the height h4, and comprises a further circular cylinder 11 having a fourth diameter d4 and a fifth height h5. The diameter d4 of the further circular cylinder 11 is larger than the diameter d3, so that the further circular cylinder 11 cannot be introduced into the mouth opening. The further circular cylinder 11 can serve as a gripping element for bringing the closure 7 from a closure position into an open position. The further circular cylinder 11 can rest at least on a portion of the mouth region.

FIG. 6 shows a sixth embodiment of a closure 8 which is designed as a truncated circular cone 8. In the illustration, a straight, truncated circular cone 8 is shown, but instead an inclined truncated circular cone can also be provided. The truncated circular cone 8 has a diameter d3 (the maximum diameter of the truncated circular cone 8) and a height h6, which can be dimensioned in such a way that the truncated circular cone 8 can be introduced in a closure position at least partially into a mouth opening of a one-piece container body comprising fibers. For example, a diameter of the mouth opening is the same size as the diameter d3 of the truncated circular cone 8, and the truncated circular cone 8 can be at least partially elastic and/or can be introduced into the mouth opening with a certain pressure, or a diameter of the mouth opening can be minimally larger than the diameter d3 of the truncated circular cone 8.

In cooperation with an inner surface of the mouth opening, the truncated circular cone 8 can be positioned at least partially with a non-positive fit in the mouth opening and can thereby close the container body.

FIG. 7 shows a seventh embodiment of a closure 9, which comprises the truncated circular cone 8 and a circular cylinder 4 with the diameter d3 and a height h4. As already described in FIG. 6, the diameter d3 is dimensioned such that, in cooperation with an inner surface of a mouth opening, the closure 9 can be positioned in the mouth opening with a non-positive fit and can thereby close the container body in the closure position.

FIG. 8 shows an eighth embodiment of a closure 10, which comprises the truncated circular cone 8 and the circular cylinder 4 with the diameter d3 and the height h4, and comprises a further circular cylinder 11 having a fourth diameter d4 and a fifth height h5. The diameter d4 of the further circular cylinder 11 is larger than the diameter d3, so that the further circular cylinder 11 cannot be introduced into the mouth opening. The further circular cylinder 11 can serve as a gripping element for bringing the closure 10 from a closure position into an open position. The further circular cylinder 11 can rest at least on a portion of the mouth region.

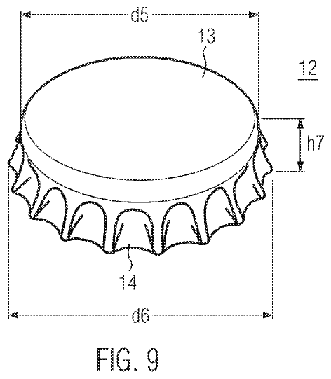

FIG. 9 shows a ninth embodiment of a closure 12, which is designed in the form of an inverted crown cap 12. The crown cap has a first diameter d5 in the lid area 13 and a second diameter d6 in a crimping area 14 at a height h7. The height h7 can be 5 mm to 20 mm. The first diameter d5 is smaller than the second diameter d6. The second diameter d6 and the height h7 can be dimensioned in such a way that the closure 12 is at least partially insertable in a closure position into a mouth opening of the one-piece container body comprising fibers. For example, a diameter of the mouth opening is the same size as the second diameter d6 of the closure 12, so that the closure 12, in cooperation with an inner surface of the mouth opening, can be positioned at least partially with a non-positive fit in the mouth opening and can thereby close the container body.

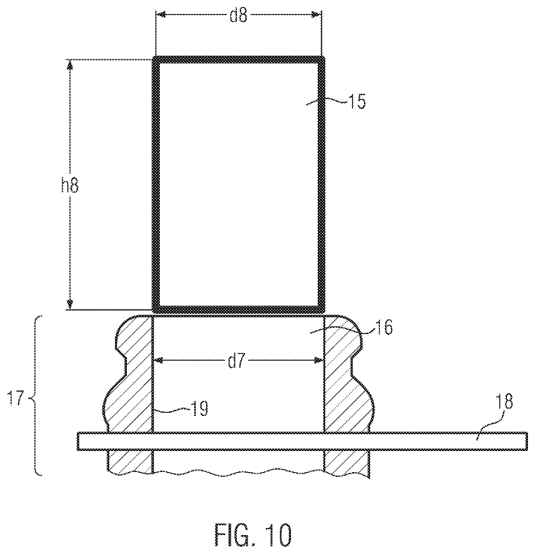

FIG. 10 shows a closure 15 in an open position. The closure 15 is designed in the form of a circular-cylindrical stopper 15 having a diameter d8 and a height h8 and is arranged completely outside of a container body in the drawing. A mouth region 17 which surrounds a mouth opening 16 with a diameter d7 can be seen on the container body. In the illustration, the mouth region 17 has a shape given as an example. In the case of another shape, for example, the upper shaft may not be provided. The mouth region 17 is retained by a clamp 18 to provide stabilization when the closure 15 is inserted in a closure position into the mouth opening 16 of the one-piece container body comprising fibers.

The diameter d8 and the height h8 of the closure 15 are dimensioned such that the closure 15 can be at least partially inserted in a closure position into the mouth opening 16 of the one-piece container body comprising fibers and, in cooperation with an inner surface 19 of the mouth opening 16, can be positioned in the mouth opening 16 at least partially with a non-positive fit, and can thereby close the container body.

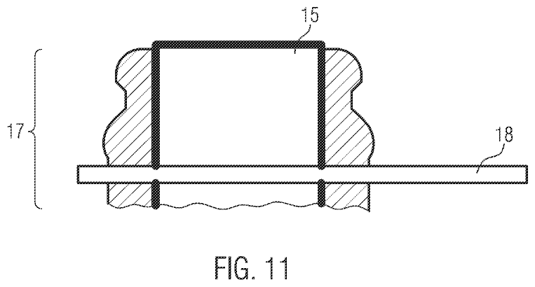

FIG. 11 shows the closure 15 in a closure position in which it has been inserted into the mouth opening 16 of the one-piece container comprising fibers. In cooperation with the inner surface 19 of the mouth opening 16, the closure 15 is positioned at least partially with a non-positive fit in the mouth opening 16 and thereby closes the container body. In the illustration, the mouth region has a shape given as an example. In the case of another shape, the upper shaft, for example, may not be provided.

1. Container having a one-piece container body comprising fibers and having a mouth opening and a closure for the container body, wherein the closure is introduced at least partially into the mouth opening in a closure position, wherein the closure, in cooperation with an inner surface of the mouth opening, is positioned at least partially with a non-positive fit in the mouth opening, and the container body is thereby closed, wherein the closure is further designed to be moved out of the closure position into an open position completely outside of the container body.

2. Container according to claim 1, wherein the closure is designed in the form of a circular-cylindrical stopper.

3. Container according to claim 2, wherein the stopper comprises a first diameter in a first region and a second diameter in a second region,
wherein, for example, the first diameter is dimensioned such that, in cooperation with the inner surface of the mouth opening, the stopper is positioned in the mouth opening with this first region with a non-positive fit,
wherein, for example, the second diameter is larger than the first diameter.

4. Container according to claim 1, wherein the closure is designed in the form of a circular cone, wherein, for example, the circular cone is a truncated circular cone, wherein, for example, a maximum diameter of the circular cone is dimensioned such that, in cooperation with the inner surface of the mouth opening, the closure is positioned in the mouth opening with a non-positive fit.

5. Container according to claim 4, wherein the circular cone further comprises a circular cylinder, wherein, for example, the maximum diameter of the circular cone and a diameter of the circular cylinder are equal in size, wherein, for example, the diameter is dimensioned such that, in cooperation with the inner surface of the mouth opening, the closure is positioned in the mouth opening with a non-positive fit.

6. Container according to claim 4, wherein the circular cone comprises a first circular cylinder and a second circular cylinder, wherein, for example, a maximum diameter of the circular cone and a diameter of the first circular cylinder are of equal size and wherein a diameter of the second circular cylinder is larger than the maximum diameter of the circular cone, wherein, for example, the maximum diameter is dimensioned in such a way that, in cooperation with the inner surface of the mouth opening, the closure is positioned in the mouth opening with a non-positive fit.

7. Container according to claim 1, wherein the closure is designed in the form of a circular cone comprising a bent tip.

8. Container according to claim 1, wherein the closure is designed in the form of an inverted crown cap.

9. Container according to claim 1, wherein at least those surfaces of the closure which can come into contact with a product present in the container comprise a coating, wherein, for example, the coating is food-safe and/or biodegradable and/or compostable and/or resistant to liquids.

10. Container according to claim 1, wherein the closure comprises a captive securing feature that connects it to the container body in a captive manner, wherein, for example, the captive securing feature comprises a biodegradable and/or compostable material.

11. Container according to claim 1, wherein the closure comprises fibers—for example, wood and/or cellulose fibers, fibers of paper, or cardboard.

12. Container according to claim 1, wherein the closure comprises a material containing cork.

13. Method for manufacturing a container body for use with the container according to claim 12.

14. Method for manufacturing a closure for use in the container according to claim 1.

15. Device for closing a container body, manufactured according to the method according to claim 13.

16. Method for closing a container body, by means of a closure manufactured according to the method according to claim 14.

17. Closure which can be at least partially inserted in a closure position into a mouth opening of a container, wherein the closure, in cooperation with an inner surface of the mouth opening, can be positioned at least partially with a non-positive fit in the mouth opening, and the container body can thereby be closed, wherein the closure is further designed to be moved from the closure position to an opening position completely outside the container body, wherein the closure comprises a fiber-containing material.

18. System for producing a sealed, fiber-containing container, comprising a device for manufacturing containers of fiber-containing material, a device for manufacturing closures of fiber-containing material, a device for closing the containers, and a transport device for transporting the containers and the closures to a position at which the containers are closed with the closures.

19. Device for closing a container body, by means of a closure manufactured according to the method according to claim 14.

20. Method for closing a container body, by means of the device according to claim 15.
